(19) United States
(12) Patent Application Publication
(10) Pub. No.: US 2010/0131335 A1
(43) Pub. Date: May 27, 2010

(54) USER INTEREST MINING METHOD BASED ON USER BEHAVIOR SENSED IN MOBILE DEVICE

(76) Inventors: Dong-hyun ROH, Yongin-si (KR); So-hee Jang, Seoul (KR); Young-jun Kim, Seoul (KR)

Correspondence Address: North Star Intellectual Property Law, PC, P.O. Box 34688, Washington, DC, 20043, US

(21) Appl. No.: 12/467,344

(22) Filed: May 18, 2009

(30) Foreign Application Priority Data
Nov. 25, 2008 (KR) 10-2008-0117386

(51) Int. Cl. G06Q 10/00; G06F 17/30

(52) U.S. Cl. 705/10; 707/E17.014

(57) ABSTRACT

A method and apparatus for modeling interests of a user based on the user's behavior and surrounding information, according to information sensed in a mobile terminal, are provided. User interest information is extracted from a mobile terminal use record of the user, situation information of the user is extracted from the mobile terminal, and user interest in a corresponding situation is modeled based on the obtained interest information and situation information.

### CROSS-REFERENCE TO RELATED APPLICATION(S)

This application claims the benefit under 35 U.S.C. §119(a) of Korean Patent Application No. 10-2008-0117386, filed on Nov. 25, 2008 in the Korean Intellectual Property Office, the disclosure of which is incorporated herein in its entirety by reference.

### BACKGROUND

1. Field

The following description relates to data mining, and more particularly, to a method and apparatus for modeling user interest information.

2. Description of the Related Art

Starting in the 1990s, technology has been researched regarding user interest modeling for a service referred to as Intelligent Web, which models individual preferences regarding websites to recommend webpages. Further, there have been attempts at practical utilization of product recommendation for stimulating sales by extracting patterns from browsing behavior, purchasing behavior, and the like of users visiting shopping malls in the field of e-commerce, and various related technologies have also been developed.

Entering into the 21^{st} century, growth of the online advertising market is accompanied by increased efforts to model users' interests based on users' behavior online. One representative case is behavioral targeting practiced on community sites such as “MySpace” and “Facebook”. Online behavioral targeting, a technique of extracting a user's interests from webpages visited by the user, has a similar basis as the Intelligent Web of the 1990s. Data mining of a user's interests has typically been performed based only on the user's behavior when online.

### SUMMARY

In one general aspect, a user interest mining apparatus includes an interest information generator for determining an interest item for interest level updating and for determining an interest level fluctuation value of the at least one interest item based on a standardized keyword list regarding a mobile terminal user's interests according to mobile terminal use information; a situation manager for obtaining situation information through the mobile terminal of the user; and a situation recognition interest manager for updating an interest model of a situation corresponding to the situation information, based on the at least one interest item and the interest level fluctuation value of the at least one interest item.

The interest model may include a plurality of parent items and a plurality of child items, and may also include a standardized keyword tree structure wherein the parent items may include or may conceptually include the child items.

The interest information generator may receives interest information from at least one selected from a group of a message processor for extracting keywords from messages sent from the mobile terminal; a recipient information processor for extracting keywords from type of business information of a recipient when the user sends a message, receives a message, or telecommunicates through the mobile terminal; a location information processor for extracting type of business information of a region proximate to the location of the user; and any combination thereof.

The situation manager may receive the situation information from at least one selected from the group of a location sensor for collecting information regarding a location of the mobile terminal; a bystander sensor for collecting information regarding people in the vicinity of the mobile terminal; a weather sensor for collecting weather information with reference to the location of the mobile terminal; and any combination thereof.

The situation manager may be configured to model a situation by obtaining the situation information within a fixed period and clustering the obtained situation information into a predetermined number of clusters.

In another general aspect, a user interest mining method includes extracting interest information of a user from a mobile terminal use record of the user; determining an interest item for interest level updating; determining an interest level fluctuation value based on the extracted interest information; extracting situation information of the user, from the mobile terminal; and updating an interest model of a corresponding situation, based on the interest item and the interest level fluctuation value of the interest item.

The interest model may include a plurality of parent items and a plurality of child items, and may further include a standardized keyword tree structure wherein the parent items may include or may conceptually include the child items.

The user interest information may include at least one selected from the group of a noun keyword extracted from messages sent from the mobile terminal; a standardized keyword based on type of business information of a recipient of a call request or messages transmitted to or received from the mobile terminal; a standardized keyword based on type of business information regarding a movement route of the mobile terminal; and any combination thereof.

The situation information may include at least one selected from the group of user location information, bystander information, weather information, time information, and any combination thereof.

Other features and aspects will be apparent from the following detailed description, the drawings, and the claims.

### BRIEF DESCRIPTION OF THE DRAWINGS

FIG. 1 is a diagram illustrating an exemplary user interest mining apparatus.

FIG. 2 is a diagram illustrating an exemplary user interest model.

FIG. 3 is a flowchart illustrating an exemplary user interest mining method.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following detailed description is provided to assist the reader in gaining a comprehensive understanding of the methods, apparatuses and/or systems described herein. Accordingly, various changes, modifications, and equivalents of the systems, apparatuses and/or methods described herein will be suggested to those of ordinary skill in the art. Also, descriptions of well-known functions and constructions may be omitted for increased clarity and conciseness.

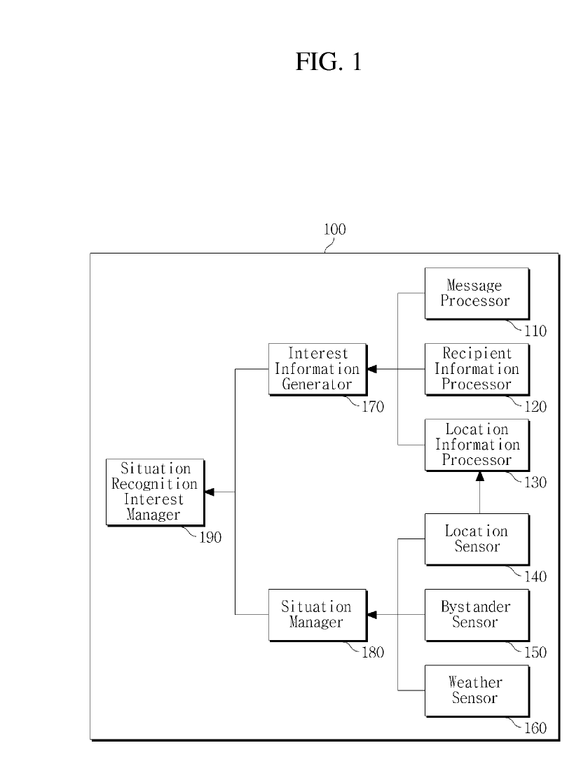

FIG. 1 is a diagram illustrating an exemplary user interest mining apparatus.

A user interest mining apparatus 100 is provided inside a user's mobile terminal and mines interests of the user based on mobile terminal use information of the user. The user interest mining apparatus 100 may be configured to transmit data to an external receiver, through a separate wired or wireless communication module (not shown) included in the mobile terminal.

Referring to FIG. 1, the user interest mining apparatus 100 includes a message processor 110, a recipient information processor 120, a location information processor 130, a location sensor 140, a bystander sensor 150, a weather sensor 160, an interest information generator 170, a situation manager 180, and a situation recognition interest manager 190.

The interest information generator 170 determines an interest item for interest level updating and an interest level fluctuation value of the interest item based on a standardized keyword list regarding the mobile terminal user's interests based on the mobile terminal use information.

The situation manager 180 obtains situational information through the user's mobile terminal within a fixed period when situation dependence is relatively high.

The situation recognition interest manager 190 updates an interest model regarding a corresponding situation by collecting the user interest information and the situation information from the interest information generator 170 and the situation manager 180. The situation recognition interest manager 190 updates the interest model regarding the corresponding situation by collecting the user interest information and the situation information of the user when the mobile terminal is offline.

Here, the user interest information describes information corresponding to a range of fluctuation of information items of current interest to the user based on data generated when the user uses the mobile terminal, regarding information items of interest to the user. Also, the user situation information describes information regarding a situation of the user that may be checked through the mobile terminal used by the user, such as a movement route of the user, the weather, and bystander information.

A method by which the interest information generator 170 generates the user interest information according to one example is described below.

The interest information generator 170 determines an interest item whose interest level may be updated and an interest level fluctuation value of the interest item based on a standardized keyword list regarding the mobile terminal user's interests based on the mobile terminal use information.

The interest information generator 170 receives interest items for generating the interest information from the message processor 110, the recipient information processor 120, and the location information processor 130. Among the received interest items, the interest information generator 170 targets interest items having a keyword list belonging to both a keyword list of the interest information generator 170 and a transferred keyword list for interest level updating.

That is, the interest information generator 170 determines the fluctuation value of the interest level of individual interest items based on a standardized keyword set transferred from the message processor 110, the recipient information processor 120, and the location information processor 130, and transfers the fluctuation value to the situation recognition interest manager 190. The interest information generator 170 may also apply information regarding whether two keywords are synonyms, from an external network such as “Wordnet”.

The message processor 110 extracts keywords corresponding to nouns from sent messages when the user performs a communication (for example, SMS, IM, and the like) with another party, through the mobile terminal. Various methods may be applied for extracting the keywords. The keywords may be extracted after standardizing by applying tokenizing, tagging, and stemming to the message.

The recipient information processor 120 extracts keywords from type of business information of a recipient when the user sends or receives a message, or performs audio or visual telecommunications through the mobile terminal. Various methods may be applied for extracting the keywords. The keywords may be extracted after standardizing by applying tokenizing, tagging, and stemming to the message. Here, the type of business information of the recipient may be obtained from a database (DB) provided inside the mobile terminal or by connecting to an external network.

The location information processor 130 obtains type of business information of a corresponding area from coordinates of the current location of the mobile terminal, through a device such as a GPS module or RF Tag module for acquiring the location of the mobile terminal. The keyword set regarding user interests is then extracted. As illustrated in FIG. 1, the location information processor 130 may receive coordinate information on the current location of the mobile terminal from the location sensor 140. Various methods may be applied for extracting the keywords. The keywords may be extracted after standardizing by applying tokenizing, tagging, and stemming to the message.

A process of the situation manager 180 extracting the situation information is described below.

The situation manager 180 extracts situation information that is mechanically sensed, regardless of the method or details of use of the mobile terminal by the user. The situation manager 180 determines a situation occurring at a corresponding time using the location information, the bystander information, and the information regarding the weather and time transferred from the location sensor 140, the bystander sensor 150, and the weather sensor 160, and transfers the result to the situation recognition interest manager 190.

The location sensor 140 obtains precise current location information of the mobile terminal from the device such as a GPS module or RF Tag module for acquiring the location of the mobile terminal, and transfers the information to the location information processor 130 and the situation manager 180.

The bystander sensor 150 determines if people are present in addition to the user carrying the mobile terminal and transfers the result to the situation manager 180. The bystander sensor 150 collects authentication information (such as unique description number (UDN) information) from mobile terminals of people in the vicinity using a short-range communication module (such as a Bluetooth module) included in the mobile terminal, and then transfers the collected information to the situation manager 180.

The weather sensor 160 obtains weather information for the region of the location of the mobile terminal according to internal or external information of the mobile terminal, and transfers the information to the situation manager 180. The weather sensor 160 may obtain the weather information by connecting to an external network.

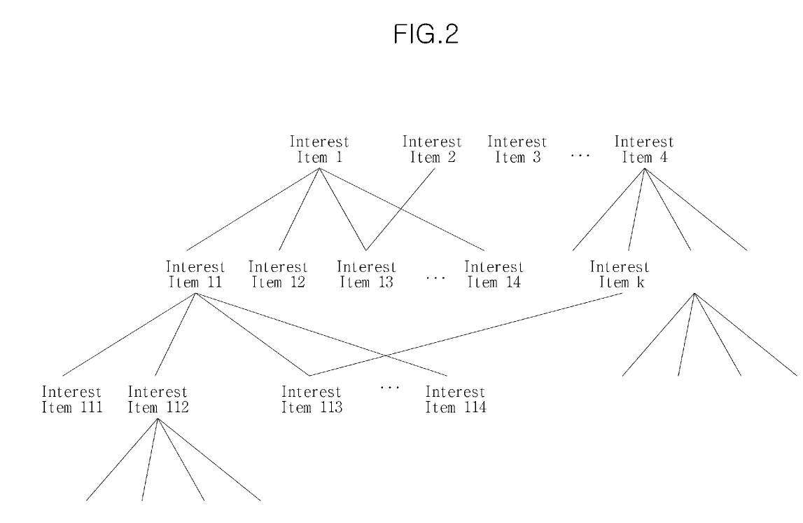

FIG. 2 is a diagram illustrating an exemplary user interest model.

The following description relates to a method of mining interests of a user based on offline user behavior and surroundings information sensed in a mobile terminal. Since interest items and interest levels can vary depending on the situation, situation-dependant user interests are modeled. In one example, interest items are determined in advance according to purpose of application, and a method of adjusting an interest level (e.g., 0-100) of each interest item is described.

As shown in FIG. 2, each interest item has a plurality of parent items and a plurality of child items, and a parent item conceptually includes a child item. Here, one interest item may be described by a plurality of synonyms, and each interest item may be described by a standardized keyword having a plurality of meanings. That is, as shown in FIG. 2, interest items modeled as a tree and the structure thereof are described as an interest model, and the act of adjusting the interest level of each interest item is described as interest modeling. An example of an interest model is illustrated in FIG. 2.

As described above, since the user's interest items and interest levels of those interest items may vary depending on the situation, interests of the user may be modeled according to the situation.

According one example, the user location information, bystander information, weather or time information, and the like, obtainable through the user's mobile terminal and dependent on the situation, may be obtained within a fixed period. Also, a situation may be modeled by a technique of clustering the information about the user's interests obtained within a fixed duration with a different fixed period, into a predetermined number of clusters.

The above operations may be performed by the situation manager 180. When the situation recognition interest manager 190 requests current situation information, the situation manager 180 obtains the user's location, bystander, and weather information from the location sensor 140, the bystander sensor 150, and the weather sensor 160. The situation manager 180 determines, according to the obtained information together with current time information, a situation that the current situation corresponds to from among previously modeled situations, and transfers an index of the current situation to the situation recognition interest manager 190. Depending on application and the mobile terminal, a variety of information further to those described above may be used in modeling the situation.

Various clustering methods such as k-means clustering, LBG, and bi-clustering may be used for modeling the situation, and various distance measuring techniques such as Euclidean distance measurement may be used in order to determine the corresponding situation.

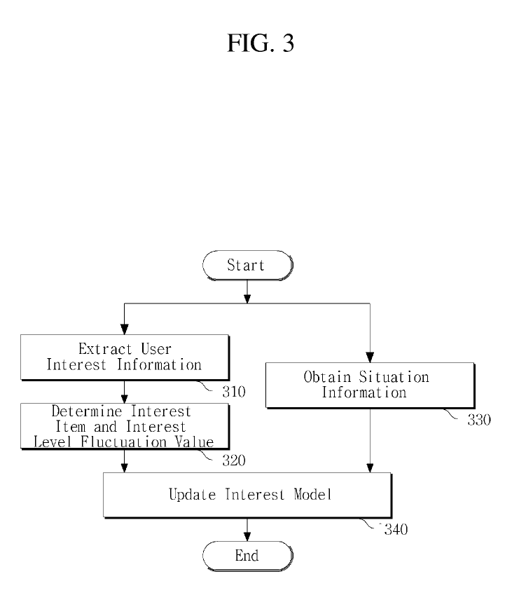

FIG. 3 is a flowchart illustrating an exemplary user interest mining method.

User interest information is extracted from a mobile terminal use record of a user (310). A keyword corresponding to a noun may be extracted from messages sent (for example, through SMS or IM), or a standardized keyword may be extracted based on type of business information (for example, of an SMS or call recipient). Also, regional information related to the user's degree of interest may be extracted by extracting a movement route of the user based on coordinate information such as GPS information. Standardized keyword information may be obtained from the above-described information by applying tokenizing, tagging, stemming, and the like.

In 310, the regional information related to the user's degree of interest may include, for example, information about commercial establishments that the user may visit. The following method is implemented to determine which commercial establishments the user is may visit according to the GPS coordinate information. If revised GPS coordinates do not pass beyond a predetermined radius within a fixed time, the probability of visiting each commercial establishment is determined to be inversely proportional to the number of target commercial establishments with regard to commercial establishments existing within a radius proportional to GPS error centered on the GPS coordinates. That is, the larger the error value, the greater the number of target commercial establishments, and thus the lower the probability of visiting each commercial establishment. Information on commercial establishments within a fixed radius centered on the GPS coordinates is obtained from a DB of an electronic map used in navigation, for example a telephone book.

In 310, interest items for interest level updating and fluctuation values of the interest levels are determined based on the extracted interest information (320).

The method described below is implemented to select interest items whose interest levels require updating. Interest items having a keyword list common to both its own keyword list and a transferred keyword list become targets for interest level updating. Information may also be applied based on two keywords being synonyms (for example, according to “Wordnet”).

A method of determining the interest level fluctuation value is described below. The fluctuation value of the interest level of an interest item is proportional to the frequency with which a keyword for the corresponding item appears in the transferred keyword list. The degree of proportionality may vary according to the purpose of application and the resulting importance of a source providing the keyword. For example, in the case of advertising service based on SMS messages, the interest level is increased by 20 for every appearance of a processed keyword in the content of the message itself, and regarding the user location information, it is possible to increase the interest level by 5 for each appearance in the transferred keyword list.

Herein, the information on the likelihood of visiting a commercial establishment from which the keyword is extracted may be received together with the location information so that the degree of proportionality of the transferred keyword may be determined as proportional to the visitation likelihood.

Concurrently with 310 or separately, situation information of the user is extracted from the mobile terminal (330). In one example, location information regarding the current location of the user's mobile terminal, bystander information, information about weather and time, and the like are extracted as the situation information.

In 320, the interest level fluctuation value of every interest item targeted for updating is determined, and when the situation information of a corresponding time is collected in 330, an interest model of the corresponding situation is updated (340).

The method of updating the interest model according to one example is described below. The interest level of an interest item transferred in 320 is increased by the amount of a corresponding interest level fluctuation value. For example, if interest in soccer is high, interest in sports can be viewed as high. Accordingly, interest in a lower ranking interest item in a tree is reflected by interest in a higher ranking interest item. Thus, updating of interest levels distributes upward.

Herein, the method of spreading the update degree may vary, including use of an update degree of a lower ranking item as an update degree of a higher ranking item, use of a value obtained by dividing an update degree of a lower ranking item by the number of lower ranking items of the higher ranking item as the update degree of the higher ranking item, use of a value obtained by dividing by a fixed value, among other methods.

While interest levels of all interest items of an interest model may be reduced by various factors, various decay functions may be defined according to the purpose of application. Interest level may decline at a fixed rate over time, it may remain unchanged for a fixed period of time and subsequently drop, or it may decline with the degree of decline fixed at a certain rate proportional to the interest level.

When the interest level declines at a fixed rate over time, the decline rate may be relatively small in an application where interest over a long period of time is the main interest target, and the decline rate may be relatively high in an application where interest over a short period of time is the main interest target.

According to the above description, based on user interest information, such as items of interest to a user and information on a type of business of a party with whom a message is exchanged or a telephone call is made, and situational information, such as a movement route of the user, weather, and bystanders obtained from a mobile terminal used by the user offline, it is possible to perform user interest mining based on the user's behavior when the user is offline.

The methods described above may be recorded, stored, or fixed in one or more computer-readable media that includes program instructions to be implemented by a computer to cause a processor to execute or perform the program instructions. The media may also include, alone or in combination with the program instructions, data files, data structures, and the like. Examples of computer-readable media include magnetic media, such as hard disks, floppy disks, and magnetic tape; optical media such as CD ROM disks and DVDs; magneto-optical media, such as optical disks; and hardware devices that are specially configured to store and perform program instructions, such as read-only memory (ROM), random access memory (RAM), flash memory, and the like. Examples of program instructions include machine code, such as produced by a compiler, and files containing higher level code that may be executed by the computer using an interpreter. The described hardware devices may be configured to act as one or more software modules in order to perform the operations and methods described above, or vice versa.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A user interest mining apparatus comprising:
an interest information generator for determining at least one interest item for interest level updating and for determining an interest level fluctuation value of the at least one interest item based on a standardized keyword list regarding a mobile terminal user's interests according to mobile terminal use information;
a situation manager for obtaining situation information through the mobile terminal of the user; and
a situation recognition interest manager for updating an interest model of a situation corresponding to the situation information, based on the at least one interest item and the interest level fluctuation value of the at least one interest item.

2. The apparatus of claim 1, wherein the interest model comprises a plurality of parent items and a plurality of child items, and comprises a standardized keyword tree structure wherein the parent items conceptually include the child items.

3. The apparatus of claim 1, wherein the interest information generator receives interest information from at least one selected from a group consisting of:
a message processor for extracting keywords from messages sent from the mobile terminal;
a recipient information processor for extracting keywords from type of business information of a recipient when the user sends a message, receives a message, or telecommunicates through the mobile terminal;
a location information processor for extracting type of business information of a region proximate to a location of the user; and
any combination thereof.

4. The apparatus of claim 1, wherein the situation manager receives the situation information from at least one selected from a group consisting of:
a location sensor for collecting information regarding a location of the mobile terminal;
a bystander sensor for collecting information regarding people in the vicinity of the mobile terminal;
a weather sensor for collecting weather information with reference to the location of the mobile terminal; and
any combination thereof.

5. The apparatus of claim 4, wherein the situation manager is configured to model a situation by obtaining the situation information within a fixed period and clustering the obtained situation information into a predetermined number of clusters.

6. A user interest mining method including:
extracting interest information of a user from a mobile terminal use record of the user;
determining an interest item for interest level updating;
determining an interest level fluctuation value based on the extracted interest information;
extracting situation information of the user, from the mobile terminal; and
updating an interest model of a situation corresponding to the situation information, based on the interest item and the interest level fluctuation value of the interest item.

7. The method of claim 6, wherein the interest model comprises a plurality of parent items and a plurality of child items, and comprises a standardized keyword tree structure wherein the parent items conceptually include the child items.

8. The method of claim 6, wherein the user interest information comprises at least one selected from the group consisting of:
a noun keyword extracted from messages sent from the mobile terminal;
a standardized keyword based on type of business information of a recipient of a call request or messages transmitted to or received from the mobile terminal;
a standardized keyword based on type of business information regarding a movement route of the mobile terminal; and
any combination thereof.

9. The method of claim 6, wherein the situation information comprises at least one selected from the group consisting of user location information, bystander information, weather information, time information, and any combination thereof.
